(19) United States
(12) Patent Application Publication
(10) Pub. No.: US 2001/0033416 A1
(43) Pub. Date: Oct. 25, 2001

(54) System and method for creating and conducting astronomical tours

(76) Inventors: Kenneth W. Baun, Trabuco Canyon, CA (US); John E. Hoot, San Clemente, CA (US)

Correspondence Address: STRADLING YOCCA CARLSON & RAUTH, IP Department, 660 Newport Center Drive, Suite 1600, P.O. Box 7680, Newport Beach, CA, 92660-6441, US

(21) Appl. No.: 09/751,328

(22) Filed: Dec. 29, 2000

Related U.S. Application Data
(60) Provisional application No. 60/173,832, filed on Dec. 30, 1999.

(51) Int. Cl. G02B 23/00

(52) U.S. Cl. 359/430; 359/399

(57) ABSTRACT

An intelligent telescope system independently acquires and tracks designated celestial objects with little to no knowledge of the night sky being required by a user. The telescope system hosts and runs an application routine in order to have the telescope system conduct a tour of interesting celestial objects that are visible from an observer's location. Tour programs are created by a user and stored in memory in the system's microprocessor controlled command module or, alternatively, pre-defined tour programs are downloaded from a repository, such as in Internet web site, for storage in the system's memory and subsequent use.

### CROSS-REFERENCE TO RELATED APPLICATIONS

The present application is related to co-pending application Ser. No. 09/428,865, filed Oct. 26, 1999, entitled FULLY AUTOMATED TELESCOPE SYSTEM WITH DISTRIBUTED INTELLIGENCE, and claims priority from U.S. provisional application Serial No. 60/173,832, filed Dec. 30, 1999, entitled SYSTEM AND METHOD FOR CREATING AND CONDUCTING ASTRONOMICAL TOURS, both commonly owned by the Assignee of the present invention, the entire disclosure of which expressly incorporated herein by reference.

### FIELD OF THE INVENTION

The present invention relates to automated telescope systems and, more particularly, to systems and methods for conducting astronomical tours using such fully automated telescope systems.

### BACKGROUND OF THE INVENTION

The continuing evolution of low cost, high performance integrated circuit processors has enabled the recent introduction of fully automatic telescope systems which are capable of performing alignment and orientation operations under software program control with a minimum of intervention by a user. Telescope systems are able to perform alignment and orientation functions regardless of whether they might be configured as an alt-azimuth telescope or as an equatorial telescope. The system is provided with sufficient processing power and with a multiplicity of application routines, such that alignment and orientation is performed with regard to a large number of different algorithms and with respect to a variety of user definable data type inputs.

Such telescope systems might be described as intelligent, in that they typically include a command module which is a fully functional microprocessor controlled command unit, capable of executing high level application software routines and performing numerous data processing tasks, such as numerical calculations, coordinate system transformations, database manipulations, and managing the functional performance of various different peripherally coupled devices.

Central interface panels might be provided on the telescope system which support interconnection between and among various intelligent motor modules, command modules and peripheral devices. Communication between and among the component parts is made over serial data and control communication channels in accordance with a packet based serial communication protocol. An RS-232 port is also provided such that a command module is able to communicate with and encoding (see, for example, Czamik, A. W. Proc. Natl. Acad. Sci, USA 1997, 94, 12738-12739). In the deconvolution approach, a large number of compounds is prepared such that the other devices in order to exchange stored information, exchange created and stored operating routines, obtain updates to programs and/or internal databases and the like. In this regard, such computer systems include a number of internal databases, including at least one database of the celestial coordinates (RA and DEC) of known celestial objects that might be of interest to an observer. Further, the system might include a database of the geographical coordinates (latitude and longitude) of a large body of geographical landmarks. These landmarks might include the known coordinates of cities and towns, cartographic features such as mountains, and might include the coordinates of any definable point on the earth's surface whose position is stable and geographically determinable. Each of the databases are user accessible such that additional entries of particular interest to a user might be included.

Given the processing power and capabilities of such automated, intelligent telescope systems, it is clear that some means must be provided in order to allow the telescope system to make full use of its capabilities in conducting astronomical observations and acting as a learning or informational tool. Such fully automated telescope systems should be able to be programmed by simple script files and be able to conduct informational tours of astronomical objects in order to enhance a user's appreciation of the night sky.

### SUMMARY OF THE INVENTION

In the context of the invention, an automated telescope system comprises an intelligent telescope, configured for rotation about two orthogonal axes and a central control processor which communicates data and control signals between and among peripheral devices through a signal bus. Intelligent motor assemblies each include an electric motor coupled to move the telescope about one of the two orthogonal axes and an intelligent control circuit, coupled to the motor and developing control signals for commanding motor movement. A tour program includes a listing of celestial objects, implemented as executable instructions and stored in a memory area of the central control processor. The tour program automatically commands telescope movement to designated ones of the celestial objects.

In one aspect of the invention, the telescope system automatically acquires each designated celestial object and automatically tracks each designated object's motion without further intervention by an operator. Each designated celestial object is identified in the program by a title string and a descriptive text string, where the title string is displayed to a user for selection, the telescope automatically slewing to the celestial object upon selection by the user. Once an object is selected, descriptive text relating to that object is displayed to the user.

In a further aspect of the invention, the system includes an object database, stored in system memory, the object data base including a listing of objects with each object having a respective name and identified by a respective location metric. The object listing of the tour program includes at least one pointer to an object stored within the object database. When such an object is included in the tour, the system automatically extracts a corresponding title string and descriptive text string for each such object stored in the object database. The tour program may also include at least one object explicitly identified by a location metric which is defined by a user. Specifically, the location metric is a position on the celestial sphere expressed in right ascension and declination coordinates.

Advantageously, the central control processor includes means for evaluating the location metric of each object in the listing and providing an alert to a user if a listed object has a corresponding right ascension and declination coordinate which indicates that the object is not above the user's horizon, and may not therefore be viewed.

In a further aspect of the invention, a method for sequentially moving among a plurality of desired objects in automated fashion comprises the steps of preparing a tour program which includes a listing of celestial objects implemented as executable instructions by a central control processor of an intelligent telescope system. The method includes storing the program in the intelligent telescope system's memory and then executing the program through the central control processor, the tour program automatically commanding telescope movement to designated ones of the celestial objects.

In a further aspect of the invention, the method includes the steps of providing an object database, stored in the telescope system's memory means, the object database including a listing of objects with each object having a respective name and identified by a respective location metric. The method includes the step of providing at least one pointer to an object stored in the object database and having the tour program automatically access the stored object and cause the telescope system to automatically slew thereto.

### BRIEF DESCRIPTION OF THE DRAWINGS

These and other features, aspects and advantages of the present invention will be more fully understood when they are considered in connection with the following detailed description, appended claims and accompanying drawings, wherein:

FIG. 1 is a semi-schematic perspective view of one embodiment of an automated telescope system suitable for practice of principles of the invention;

FIG. 2 is a semi-schematic front view of an intelligent electronic telescope control system in accordance with the invention;

FIG. 3 is a simplified, semi-schematic block diagram of one embodiment of the configuration of the electronic components of the intelligent electronic telescope control system of FIG. 2;

FIG. 4 is an exemplary illustration of a portion of one embodiment of an astronomical tour structure, in an automated;

FIG. 5 is an exemplary illustration of a portion of one embodiment of an astronomical tour structure, in a manual mode;

FIG. 6 is an exemplary table containing a listing of keyword statements suitable for practice of the invention; and

FIG. 7 is an exemplary illustration of one embodiment of a program listing implementing a “PICK” feature in accordance with the invention.

### DETAILED DESCRIPTION OF THE INVENTION

The detailed descriptions of various systems and methods for preparing and conducting astronomical tours in conjunction with a fully automated telescope system, are intended only as a description of the presently preferred and illustrated embodiments of the invention, and are not intended to represent the only forms in which the present invention may be implemented or utilized. The detailed descriptions set forth the construction and function of the invention as well as the sequence of steps utilized in the operation of the invention in connection with the illustrated embodiments. It is to be understood by those having skill in the art, that the same or equivalent functionality may be accomplished by various modifications to the exemplary embodiments without departing from the spirit and scope of the invention.

Briefly, the invention relates to a fully automated telescope system of a type that can independently acquire and track designated celestial objects with little to no knowledge of the night sky being required of a user. The telescope system is capable of hosting and running an application routine that may be implemented and run in conjunction with a microprocessor controlled command module such as described in co-pending patent application Ser. No. 09/428,865, filed Oct. 26, 1999, the entire contents of which are expressly incorporated herein by reference. Once the fully automated telescope system has oriented itself with respect to the celestial coordinate system, a user is able to launch the application routine in order to have the telescope system conduct a tour of interesting celestial objects that are visible from the observer's location. Tour programs are created by a user and stored in memory in the system's microprocessor controlled command module or, alternatively pre-defined tour programs are downloaded from a repository, such as an Internet Web site, for storage in the system's memory and subsequent use.

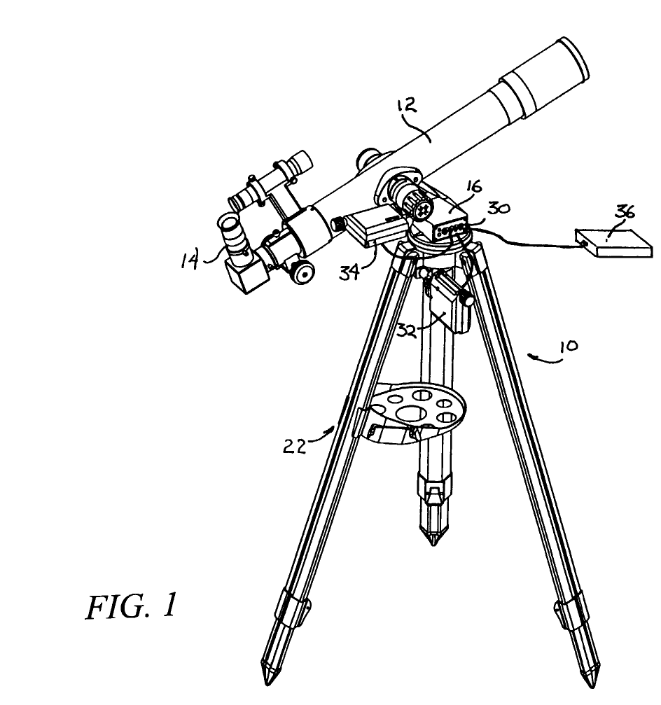

A fully automated telescope system, including a microprocessor controlled command module for operating the system and for storing and executing astronomical tour programs will now be described in connection with the exemplary embodiment of FIG. 1.

In FIG. 1, a telescope system 10 for observing celestial and terrestrial objects is provided in accordance with the present invention. The telescope system 10 suitably comprises a telescope tube 12 which houses the optical system required for resolving distant objects and includes a focusing objective and eye piece 14 coupled to the optical system in a manner to allow observation of the optical system's focal plane. A mount 16 supports the telescope tube 12 and facilitates movement of the telescope about two orthogonal axes, a substantially vertical axis, termed an azimuth axis, and a substantially horizontal axis, termed an altitude axis. As those having skill in the art will appreciate, the horizontal and vertical axes of the mount 16 define a gimbaled support for the telescope tube 12 which enables it to pivot horizontally and vertically, about its defined horizontal and vertical axes.

It should be noted, at this point, that the telescope system 10 is illustrated as comprising a telescope tube 12 configured as a refracting-type telescope. However, the form of the telescope's optical system, per se, is not particularly relevant to practice and principles of the invention. Thus, even though depicted as a refractor, the telescope system 10 of the present invention is eminently suitable for use with reflector-type optical systems. Suitable optical systems might be Newtonian, Schmidt-Cassegrain, Maksutov-Cassegrain, or any other conventional reflecting or refracting optical system, configured for telescope use.

A tripod, indicated generally at 22, conventionally functions to support the mount 16 such that the telescope's azimuth axis 18 is substantially orthogonal to a horizontal plane, relative to the telescope system. The tripod 22 suitably includes three legs which are arranged in a triangular pattern. Each of the legs are independently adjustable for leveling the mount 16, regardless of the nature of the surface on which the telescope system 10 is used.

Motion of the telescope about its orthogonal axes, is controlled by intelligent drive motors; an intelligent azimuth motor 32 coupled to the azimuth axis, and an intelligent altitude motor 34 coupled to the altitude axis. Intelligence, in the context of the motors 32 and 34, means that each motor is controlled by its own separate micro-controller, which develops motor motion commands and evaluates actual telescope movement by receiving telescope motion feedback signals from respective optical encoders (not shown) coupled to each axis. Motor movement commands are generated in operative response to telescope motion control signals generated by an intelligent command module 36, provided for such purpose. The intelligent motors 32 and 34, and the intelligent command module 36, are coupled together over a serial interface whose connections are made through an electrical interface junction panel 30.

In operation, a user plugs the intelligent control module 36 into an appropriate receptacle of the electrical interface junction panel 30 and further plugs the intelligent motors 32 and 34 into their respective receptacles, thus completing a signal path between each of the motors and the intelligent command module 36. Telescope motion commands are provided to the system by the user accessing the appropriate function provided on the intelligent command module 36. Telescope movement signals, corresponding to the desired telescope displacement, are directed, by the intelligent command module 36, to the appropriate motor through the electrical interface junction panel 30. Each intelligent motor, in response, independently develops motor movement commands which cause the motor to operate, and each independently evaluates actual motor operation and thus actual telescope movement, by receiving and analyzing motion feedback signals. The actual construction and operation of the intelligent control portions of the telescope system 10 are described in copending patent application Ser. No. 09/428,865, filed Oct. 26, 1999, commonly owned by the assignee of the present invention, the entire contents of which are expressly incorporated herein by reference.

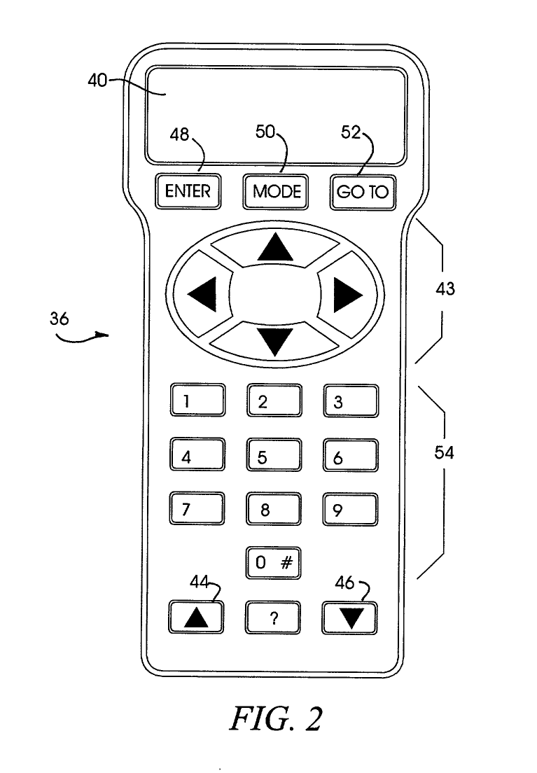

Turning now to FIG. 2, an exemplary embodiment of a command module (or intelligent controller), indicated generally at 36, consists of a hand-held package which functions as a full-spectrum control unit capable of intelligently defining and commanding the telescope movements required for astronomical observations, as well as capable of implementing various pre and post processing features in a manner similar to a microcomputer. The intelligent controller 36 suitably comprises an LCD display screen 40 capable of displaying text, numeric and graphical output data, that might be consulted by a user in operating the telescope system. All prompts, user queries, confirmation messages, and the like, are displayed on the LCD screen 40. Telescope motion direction keys 42, typically labeled with directional arrows, indicating up, down, right and left, provide the necessary inputs for enabling the telescope system to move, or micro slew in a specified direction, at any one of a number of allowable, and user settable speeds.

Scroll keys, suitably an “up” scroll key 44 and a “down” scroll key 46, are also provided in order that a user may scroll through a database listing or through available menu options that contain various executable software routines as will be described presently. Particular keys might further access an internal “help” file which, when depressed, might cause the LCD screen 40 to display a brief description of the selected menu item on the first line of the display. An “enter” key 48 selects a file menu or application program option, or is used to define the completion of an entry made in response to a system prompt. A “mode” key 50 might allow a user to exit a current menu to return to a previous menu and a “go-to” key 52 might invoke a command which causes the telescope system to automatically slew the telescope to the corresponding celestial coordinates of an object chosen from an internal celestial object database listing, for example.

Suitably, the intelligent controller 36 includes a numeric keypad 54 which allows an operator to enter various commands, data, or other forms of input supported by the system. For example, an operator is able to control telescope slew rate, as well as defeat the system's sidereal motion rate in the event that the operator wishes to view planetary objects, cometary objects or satellites. Manual data entry is performed by manipulating the keys of the numeric keypad 54.

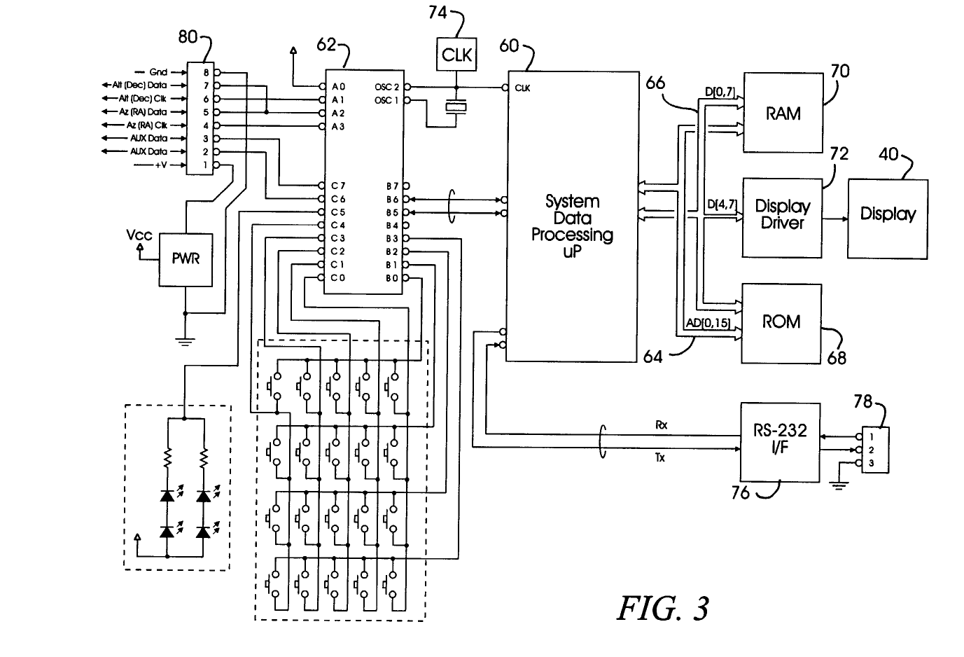

Turning now to FIG. 3, there is shown a simplified, semi-schematic block diagram of one embodiment of the electronic components of an intelligent command module such as described in connection with FIG. 2, above. The internal construction of the intelligent controller is suitably implemented in the form of a dual processor system, with the dual processing functions implemented by a first, general purpose microprocessor 60 exemplified by a 68HC11, a member of the 68HCxx family of microprocessors manufactured and sold by Motorola, and a second, purpose configured microprocessor or micro controller 62, exemplified by the PIC16C57 micro controller manufactured and sold by Microchip Technology, Inc. Although described with particularity in connection with the exemplary embodiment of FIG. 3, either the general purpose microprocessor 60 or the purpose configured micro controller 62, or both, can be sourced from a variety of other vendors, and would be equally suitable for use in the invention even though provided in a variety of different architectures.

The general purpose microprocessor 60 is coupled to a 16-bit address and data bus 64 and an 8-bit data bus 66, which allow the microprocessor to communicate with a programmable read-only memory (ROM) 68 and a random access memory (RAM) 70. Further, the four most significant bits of the data bus are coupled to the system's LCD display driver circuit 72 in order to provide an interface between the microprocessor and the system's LCD display (40 of FIG. 2). In particular, the microprocessor 60 is responsible for implementing the system's top-level firmware architecture and for executing down-loadable application software routines pertinent to the exemplary intelligent telescope system.

The programmable read-only memory circuit 68, is preferable implemented as a Flash Programmable Read Only Memory (FPROM), and is provided in order to host the instruction set for downloaded applications and software routines, data tables, such as a stellar object position database, the Messier object catalog list, an earth-based latitude/longitude correspondence table, and the like. Although described as an FPROM, the ROM memory 68 may be implemented as an EEPROM, or any other type of programmable non-volatile memory element. Indeed, the ROM might be implemented as an external mass storage unit, such as a hard disk drive, a programmable CD-ROM, and the like. All that is required, is that the memory be able to be written to, in order that its hosted databases and tables may be updated and that various downloadable application software routines might be added thereto, and be non-volatile, in order that its hosted databases, tables and application software routines be available to the system upon boot-up or power-on-reset.

In accordance with the present invention, the microprocessor 60 performs high level application software execution tasks and the associated data handling and numerical processing, in order to define the appropriate telescope motion commands to be provided to the purpose configured micro controller 62. The micro controller receives telescope motion command inputs from either the microprocessor or the user interface keys over an interface bus, and suitably processes the received telescope motion commands into command and control signals suitable for use by a motor movement control processor incorporated in an intelligent motor system.

In order to give the microprocessor some means of performing time calculations appropriate to celestial motion, a real-time clock 74 is provided and is coupled to a clock input of the microprocessor 60, as well as being provided to a clock input of the micro controller 62. The real-time clock is preferably implemented as a precision timing reference clock signal generator, such as a UTC clock, that is used by the microprocessor to calculate sidereal time intervals and preferably resides as an integral component of the command module. Alternatively, the clock might be implemented as a separate, off-board integrated circuit comprising a conventional UTC clock which communicates with the system over an RS-232 interface, or an on-board UTC clock and follow-on circuitry for converting UTC time intervals to sidereal time intervals prior to providing a timing reference signal to the microprocessor.

A further advantageous feature of the present invention relates to the ability of the command module to be coupled to a personal computer (PC), whether configured as a desktop, laptop, palm, or otherwise. The command module is provided with an RS-232 interface 76, which allows for direct serial data communication between the module and any similarly provided computational device, such as a PC. The RS-232 interface is coupled to a suitable data input of the microprocessor 60 and to a serial RS-232 port provided in the module housing. Alternatively, data communication is made between the module and exterior, peripheral devices (such as the previously mentioned personal computer types) over an auxiliary port (AUX Port) provided in the electrical interface junction panel (30 of FIG. 1) which is illustrated in simplified form in the embodiment of FIG. 3 at 80. The panel allows for serial data communication with the altitude motor system (over Alt or Dec Clk and Data lines), the azimuth motor system (over Az or RA Clk and Data lines) and an auxiliary peripheral device (over AUX Data lines). All that is required is that an external device be coupled to the AUX port, using a serial/RJ-11 coupling, whence data is communicated between the external device and the microprocessor 60 through the micro controller 62.

This particular feature is advantageous in that it allows either user prepared or third-party developed tour programs to be simply and efficiently downloaded from a computing device. Program material is prepared on the computer, in a manner to be described in greater detail below, and loaded into module memory for eventual execution. Similarly, program material is downloaded from a repository hosted on a third-party Web site and either manipulated by an eventual user for subsequent module storage and execution or, directly ported through the user's computer to the module.

Once the general features of the automated telescope system according to the invention are understood, application software routines, capable of controlling the motion of the telescope system may be implemented in a manner to create what might be termed custom astronomical tours. Custom astronomical tours typically consist of a list of specified objects chosen by and presented in the order and style defined by a user. Such specific objects might include any of the items contained within the automated telescope system's database listing of stellar objects, user defined locations in the night sky, geographic/cartographic reference points, and the like. Objects so chosen and presented in the specified order, may be used to introduce people to the wonders of the night sky, or to enhance an astronomy lesson plan. An astronomical tour might be designed around certain specific themes, such as a tour of the brightest objects in the sky; a comparison of open star clusters; an illustration of the differences between spiral and elliptical galaxies, and the like. Custom astronomical tours are limited only by the imagination of their creator.

Custom astronomical tours are identified in an internal database listing, for example, by a file title and, when selected from the database by appropriate use of the command module, provides an executable control script to the intelligent telescope system which causes the telescope to sequentially move through the heavens, such that selected objects are presented to an operator in the order in which they are listed within the tour script file. Custom astronomical tours may be written such that a description of each object is displayed on the command module's LCD screen when the automated telescope system is pointing at that object. In order to view a particular object, or to view a next object in the tour, the user need only depress the “go-to” key of the command module and the telescope automatically moves to the celestial coordinates corresponding to the position of the object, and subsequently automatically follows the object's track through the sky. The user is able to move forward or backward within a particular tour using the menu selection techniques described in co-pending patent application Ser. No. 09/428,865.

Before presenting an object in a tour, the intelligent telescope system verifies that the object selected is indeed far enough above the horizon to be visible. If an object is not high enough above the horizon, the intelligent telescope system automatically skips through the object list to the next object in the tour which it determines is visible. This particular feature is enabled by the unique orientation methodology practiced by the intelligent telescope system of the invention. Telescope alignment and orientation is described in detail in co-pending U.S. patent application Ser. No. 09/428,865, and need not be described further herein. However, it should be noted that the telescope system's orientation methodology allows the system to explicitly understand its particular spatial

As exemplified above, the first compound on the thread, “adi”, is not repeated until position 106, with respect to a right ascension (RA) and declination (DEC) mark, all other celestial coordinates become explicitly determinable.

Tours may be created either by using objects from within the telescope's internal celestial object database listing, or a user may manually enter previously uncaptured objects, such as a newly discovered comet, a recently disposed satellite, or the like. As will be described in greater detail below, such objects, which might be termed ephemeral objects need to be defined in terms of their proper motion with respect to the celestial sphere. If an object's ephemeris data is known, equations of proper motion can be easily implemented and included in the script file comprising a custom astronomical tour.

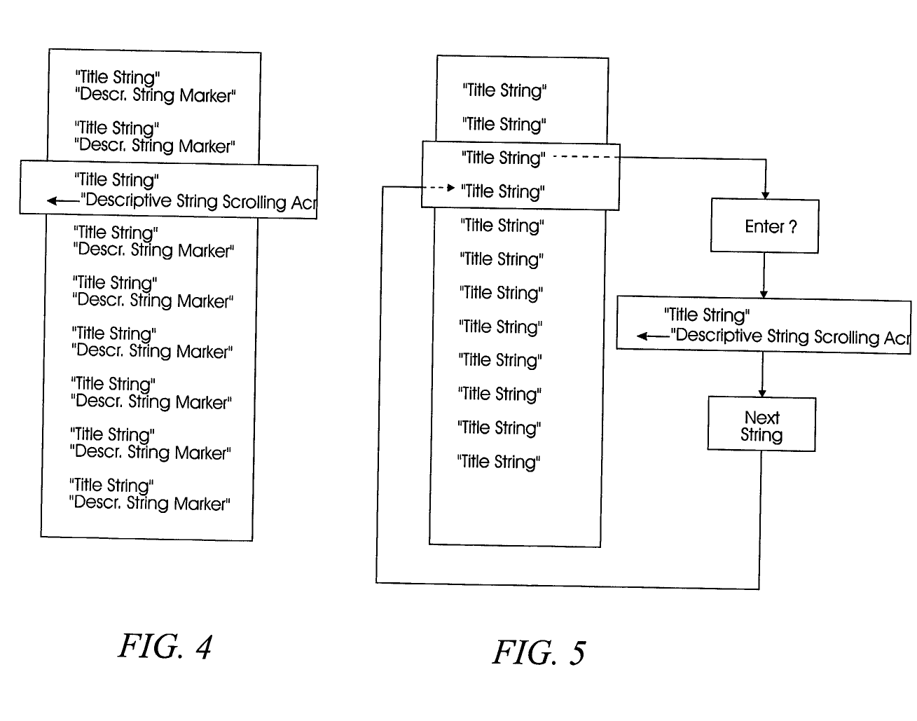

Having recourse now to the exemplary illustrations of astronomical tour structures of FIGS. 4 and 5, objects within a tour can be presented to the user over the module display in two different modes; automatic mode as exemplified by the embodiment of FIG. 4, or interactive mode as exemplified by the embodiment of FIG. 5. The author of the tour is able to determine how objects are presented by choosing one of these two modes when writing the command file for a particular tour. In the automatic mode, as the system advances from object to object, the title of the object appears on line 1 of the system's LCD display screen while descriptive text automatically scrolls across line 2 of the LCD display. In interactive mode, as the system advances from object to object, the tour name appears on line 1, while the name of the next object in the tour is displayed on line 2. In order to access an object's description while in interactive mode, the user can depress the “enter” key which causes descriptive text to scroll across the LCD display. After the descriptive text has been displayed, the system reverts to sequential object display.

A custom astronomical tour is typically created as an ASCII text file that is commonly implemented as a list of execution instructions (a list of directions) for the command module's microprocessor, along with descriptive text that it is desirable to display when the telescope system is pointing at a particular celestial object. Custom astronomical tours may be created using any text editor or word processor software, as long as the application routine can save the created file in a format appropriate for recognition by the microprocessor. In the particular embodiment of the invention, files are saved as “text only” or “MS DOS text” files, in order to be compatible with the described system. Given other system architectures, files may be written and/or stored in other formats. Following convention, each line of a tour script file will either be a comment line, a command line, or the continuation of a descriptive text string.

Comment lines allow the tour creator to include information in their tour that they wish to keep on file, but do not wish to be displayed during implementation of the tour on an intelligent telescope system. Comment lines may typically include authorship credits, revision histories, copyright notices, a course number or lesson number and the like. As is conventional, comment lines begin with a / character in column 1 of the line, but might be identified by any other ASCII delineator that identifies a following character string as a comment field.

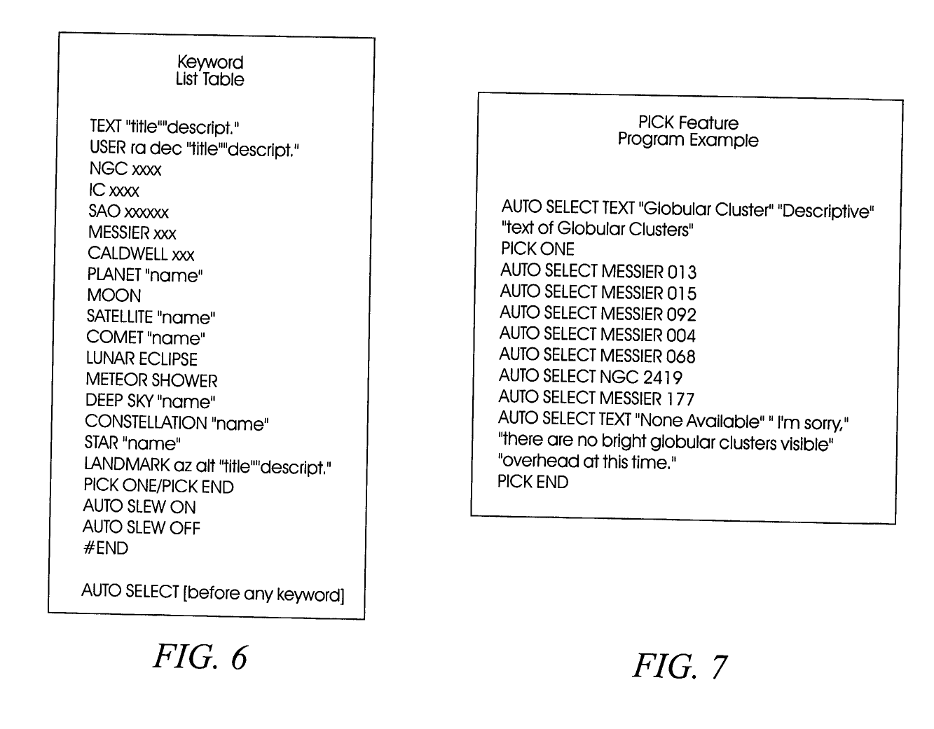

Command lines typically include a keyword, RA and DEC coordinates, a title string or a description string. Keywords describe various actions to be performed during the tour and might be preceded by an “AUTOSELECT” qualifier. If this qualifier appears on a command line, the intelligent telescope system will execute the command automatically (in the automatic mode) if the qualifier is not present, the command will typically be executed in the interactive mode. RA and DEC indicate the right ascension and declination of a particular object to which the telescope is to point. Examples of keywords recognized by the system are given in the keyword listing table of FIG. 6 and include certain keywords, identified in italicized text in the table of FIG. 6, which extract catalog objects from an internal database, hosted by the system, along with descriptive text, and automatically incorporates this material into a respective “stop” on the tour. Other keywords, particularly the USER keyword, allows objects not contained in the system's internal database to be specified by the user directly. All the user need do is provide right ascension and declination coordinates for the object and prepare a description string, in order that the object is available for viewing as part of a tour.

Text within a title string is displayed as the title of the selected object. In interactive mode, the title string appears on line 2 until the text is selected with the “enter” key. In automatic mode, or after interactive mode selection, the title string appears on line 1 as the descriptive string scrolls across line 2. The title string is surrounded by quotation marks and is able to contain up to 16 characters, i.e., “M17” or “My Favorite Star,” for example.

Description strings are surrounded by quotation marks and text within this string appears as the description for any selected object. Because object descriptions may be longer than one line, it is necessary to end each line with a quotation mark and a hard return. The next description line (the continuation) is begun with a quotation mark. If a quotation mark is desired within the description string, two quotes together, at the beginning and end of the desired phrase, are used. For example, “this nebula is considered ““awesome”” by many who view it.”

Various key words and command line examples are given in the accompanying Appendix entitled “Tour Program Command Appendix,” the contents of which are expressly incorporated herein by reference. As will be evident from the accompanying Appendix, certain commands are able to specify objects that are already contained in various internal object database listings comprising the telescope system's command module. Certain of the desired objects contained within these databases also include a description of the object as part of its database listing. When entering commands that specify objects that are already in the system's database listings, and if these commands follow the “auto select” command, the object's title will appear on line 1 while its description scrolls across line 2 of the system's LCD display. Further, placing the “auto select” command before any of the command keywords, causes the system to activate automatic mode and, when so selected, the system automatically searches the sky for the designated object, acquires the objects and proceeds to automatically track that object's motion.

A further particular function, termed “AUTOSLEW,” is also implemented by the custom astronomical tour application. When “AUTOSLEW” is on, the telescope system automatically slews the telescope to the selected object first, before displaying the text description. This particular feature is helpful when designing tours in which observing certain objects is required in order that the text description makes sense. For example, an astronomy professor may require students to observe the first four objects on a tour and then have the last two objects identified for extra credit. When constructing the tour routine, “AUTOSLEW” would be turned on before the first required object is listed and “AUTOSLEW” be turned off after the fourth listed object. Students might then manually slew the telescope system to the last two extra credit objects.

An additional advantageous feature of the tour application program is the “PICK” feature. Two keyword statements PICK ONE and PICK END are used to surround a list of items that the system may choose from during a tour. The system begins tour presentation selection at the first object following the PICK ONE command that is above the horizon and displays that object. Following objects are displayed sequentially, so long as they are above the horizon of the operator (i.e., above the horizon of the telescope system).

An example of a tour developed in connection with the PICK feature is illustrated in FIG. 7, and is particularly useful for developing tours that can be presented year round. In the exemplary tour listing of FIG. 7, a number of Messier objects (and one NGC object) are presented and have been selected so as to be disposed across the range of right ascension. The objects are bracketed by PICK ONE and PICK End statements so as to establish a choice listing. The last “Auto Select” statement in the list is a text statement which will appear on the user's display if none of the objects in the “PICK” list are visible. The “PICK” listing may be preceded with an “Auto Select” Text statement which identifies the particular content of objects defined within the “PICK” listing. Also, since the objects are “Auto Selected”, each will have its corresponding descriptive text extracted from the system's internal database as it is accessed. Naturally, a “PICK” listing can be expressed as a list of “Auto Select” objects, “USER” defined objects, or a combination of such objects.

Once a tour is written and stored as an ASCII text file, it is able to be loaded into the command module of an intelligent telescope system using the update utility provided on a personal computer. As tours are downloaded into the intelligent telescope, by virtue of its RS-232 capability, the intelligent telescope system is able to examine the programming and, if errors occur, questionable areas are flagged and returned to the personal computer which displays them in a pop-up window. Necessary corrections may then be made and the corrected custom tour routine may be downloaded again.

It will be evident that a number of custom astronomical tours can be created by various personal computer users and which may also be shared with one another across an Internet connection, for example. Alternatively, a multiplicity of tours might be maintained within a database hosted on an Internet web site, which can be accessed and various tours be downloaded, either to a personal computer or through the personal computer directly to the intelligent telescope system's command module.

It should be understood, therefore, that the creation and implementation of custom astronomical tours is not limited to the particular configuration of the telescope, nor to the particular means by which the tours are created or hosted. Certain portions of the system may be further integrated into the component electronic parts of an automated telescope system without sacrificing any of the virtues of the distributed nature of the tour creation methodology.

1. An automated telescope system comprising:
an intelligent telescope configured for rotation about two orthogonal axes;
a signal bus, configured to pass data and control signals between and among peripheral devices connected thereto;
a central control processor coupled to the signal bus, the control processor including memory means for storing executable instructions, the control processor communicating data and control signals between and among peripheral devices coupled to the signal bus, said control signals including telescope positioning commands;
first and second motor assemblies, each motor assembly including:
an electric motor coupled to move the telescope about one of the two orthogonal axes;
an intelligent control circuit coupled to the motor and to the signal bus, the intelligent control circuit developing control signals for commanding motor movement; and
a position indication circuit coupled to a respective axis and to the control circuit, the position indication circuit providing position indication signals to the respective control circuit; and
a tour program including a listing of celestial objects, implemented as executable instructions and stored in the memory means, the tour program automatically commanding telescope movement to designated ones of said celestial objects.

2. The automated telescope system according to claim 1, wherein the telescope automatically acquires each designated celestial object and automatically tracks each designated object's motion without further intervention by an operator.

3. The automated telescope system according to claim 2, wherein the central control processor includes a display, the tour program further comprising:
a title string for each of the celestial objects;
a descriptive text string for the celestial objects; and
wherein the title string is displayed to a user for selection, the telescope automatically slewing to the celestial object upon selection by the user.

4. The automated telescope system according to claim 3, further comprising:
an object database, stored in the memory means, the object database including a listing of objects each object having a respective name and identified by a respective location metric; and
wherein the celestial object listing of the tour program includes at least one pointer to an object stored in the object database.

5. The automated telescope system according to claim 4, wherein the celestial object listing of the tour program includes at least one object explicitly identified by a location metric defined by a user.

6. The automated telescope system according to claim 4, wherein the location metric is a position on the celestial sphere expressed in right ascension and declination.

7. The automated telescope system according to claim 6, wherein the central control processor includes means for evaluating the location metric of each object in the listing, the central control processor providing an alert to a user if a listed object is not above the user's horizon.

8. In an automated telescope system of the type including an intelligent telescope configured for rotation about two orthogonal axes, the telescope having a central control processor including memory means for storing executable instructions, the control processor configured to automatically command telescope movement to an object upon designation of the object by an operator in operative response to said executable instructions, a method for sequentially moving among a plurality of desired objects in automated fashion comprising:
preparing a tour program, the program including a listing of celestial objects, implemented as executable instructions;
storing said program in the memory means; and
executing the program through the central control processor, the tour program automatically commanding telescope movement to designated ones of said celestial objects.

9. The method according to claim 8, further comprising:
defining a title string for each of the celestial objects;
defining a descriptive text string for the celestial objects; and
wherein the title string is displayed to a user for selection, the telescope automatically slewing to the celestial object upon selection by the user.

10. The method according to claim 9, further comprising:
automatically acquiring each designated celestial object; and
automatically tracking each designated object's motion without further intervention by an operator.

11. The method according to claim 10 further comprising the step of displaying a description of each acquired object to a user.

12. The method according to claim 10, further comprising:
providing an object database, stored in the memory means, the object database including a listing of objects each object having a respective name and identified by a respective location metric;
providing at least one pointer to an object stored in the object database; and
wherein the tour program automatically accesses the stored object and causes the telescope to automatically slew thereto.

13. The automated telescope system according to claim 12, wherein the celestial object listing of the tour program includes at least one object explicitly identified by a location metric defined by a user.

14. The automated telescope system according to claim 13, wherein the location metric is a position on the celestial sphere expressed in right ascension and declination.

15. The automated telescope system according to claim 14, wherein the central control processor evaluates the location metric of each object in the listing, the central control processor providing an alert to a user if a listed object is not above the user's horizon.

16. In an automated telescope system of the type including an intelligent telescope configured for rotation about two orthogonal axes, the telescope having a central control processor including memory means for storing executable instructions and a display, the control processor configured to automatically command telescope movement to an object upon designation of the object by an operator in operative response to said executable instructions, a system for commanding sequential motion among a plurality of desired objects in automated fashion comprising:
a tour program, the program including a listing of celestial objects, implemented as executable instructions and stored in the memory means, the tour program automatically commanding telescope movement to designated ones of said celestial objects;
a title string for each of the celestial objects;
a descriptive text string for the celestial objects; and
wherein the title string is displayed to a user for selection, the telescope automatically slewing to the celestial object upon selection by the user.

17. The system according to claim 16, further comprising:
an object database, stored in the memory means, the object database including a listing of objects each object having a respective name and identified by a respective location metric; and
wherein the celestial object listing of the tour program includes at least one pointer to an object stored in the object database.

18. The system according to claim 17, wherein the telescope automatically acquires each designated celestial object and automatically tracks each designated object's motion without further intervention by an operator.

19. The automated telescope system according to claim 18, wherein the celestial object listing of the tour program includes at least one object explicitly identified by a location metric defined by a user and, wherein the location metric is a position on the celestial sphere expressed in right ascension and declination.

20. The system according to claim 19, wherein the central control processor includes means for evaluating the location metric of each object in the listing, the central control processor providing an alert to a user if a listed object is not above the user's horizon.
